(19) United States
(12) Patent Application Publication
(10) Pub. No.: US 2005/0074318 A1
(43) Pub. Date: Apr. 7, 2005

(54) Kneeling vacation trailer with upswinging rear door, removable carrier, and detachable bumper

(76) Inventor: Raymond F. Howard, Victoria (CA)

Correspondence Address: RAY HOWARD, 1751 DENMAN STREET, VICTORIA, V8R1Y3, IO

(21) Appl. No.: 10/677,991

(22) Filed: Oct. 3, 2003

(51) Int. Cl. B62B 1/00

(52) U.S. Cl. 414/482

(57) ABSTRACT

A vacation trailer having, in addition to conventional features: an upward-opening rear door to roof over a sheltered area behind the trailer when parked; means for causing the trailer to kneel in a manner lowering the bumper-bearing end of the chassis of the trailer; a specially designed removable drawer-like carrier on casters which fits into the interior of the trailer and is useful for unloading a quantity of outdoor portable items all at once from the trailer; and a detachable bumper containing a cavity for storage of folded or rolled fabric and/or screening material useful for walling-in the sheltered area under the opened rear door. Mutual cooperation among the special elements procures convenient unloading of the portables and convenient erection of the door-roofed sheltered area.

### CROSS-REFERENCE TO RELATED APPLICATIONS

Not Applicable

### STATEMENT REGARDING FEDERALLY SPONSORED RESEARCH OR DEVELOPMENT

Not Applicable

### DESCRIPTION OF “MICROFICHE APPENDIX”

Not Applicable

### BACKGROUND OF THE INVENTION

1. Technical Field

In general, this invention relates to a combination of special technical elements for a non-selfpropelled land vehicle structure of the towed “vacation trailer” or “camping trailer” type. Well-suited to provision of inexpensive accomodation for vacationers who tow such a trailer behind an automotive vehicle when travelling, overall structure for this type trailer typically comprises a chassis with towing hitch at the front, a set of roadable wheels, suitable suspension means connecting the chassis with the set of wheels, a securely mounted fibreglass body including a movable closure for access to usable volume within the body, and a bumper affixed at the rear of the chassis. The movable closure for access to such vacation trailers is normally a simple door vertically hinged at one edge and located at a position on one side of the trailer body, closer to the front than to the rear. Windows on both sides and at both front and rear are also normally included. Respecting usual internal layout or, ie., floorplan of such trailers, an area opposite the side door is normally occupied by a gas-fueled stove and/or a small refrigerator, often with the former resting atop the latter.

The present invention more particularly relates to a vacation trailer having, besides the aforesaid side door and other conventional features, four categories of special elements to be described below with attention to mutual functional cooperation among them: (first) trailer kneeling means integral to the wheels-to-chassis suspension means; (second) a specially designed removable carrier for accomodating portable goods transported inside the trailer during towing thereof; (third) a rearwardly located movable closure, ie., door, that, when the trailer is parked for use as accomodation, is so held open after swinging upwardly that it furnishes roofing structure for a sheltered area behind the trailer body; and (fourth) a special detachable bumper having a cavity for storage of folded or rolled weather-proof fabric and/or screening material. Owing to mutual cooperation amongst the four special elements, overnight accomodations may be set up with exceptional ease after a day of driving and travel.

Towable accomodation in the form of an “aerodynamically clean” vacation trailer is desired by many vacationers who recognize that the more poorly designed a trailer of given weight capacity is from the standpoint of aerodynamics, the greater is extra expense in fuel costs.

Therefore, for reason of fuel-consciousness as well as for aesthetic reasons, many vacation trailer users prefer a smoothly rounded trailer body design. In other words, corners and edges on an otherwise basically box-like vacation trailer are preferred to be rounded, and this result is of course readily attained by use of a fibreglass molding technique. Exhibiting the rounded-off kind of body shape that became instantly popular when introduced in Canada in the late 1960s was a lightweight trailer about thirteen feet long that was originally manufactured in Winnipeg, Nanitoba, Canada, by Boler Manufacturing Limited, Ray Olecko, president.

2. Description of Related Art

Although not associated with a trailer, one comparatively pertinent accomodation enclosure structure which vacationers may use was disclosed in U.S. Pat. No. 4,867,502 issued Sep. 19, 1989 to Christopher and Nary Sylvester for their “VAN CAMPER”. The Sylvesters teach erection, at the rear of a van having an upswinging rear door, of a tent-like enclosure having a top which fits over the opened van door, thereby receiving positioning itself, while at the same time covering the door. To a limited but nonetheless specified extent, the door is not the only element of the van to cooperate with the tent-like enclosure structure. The rear bumper of the van concerned cooperates somewhat, insofar as an elastic rope material sewn into hems of tent material makes contact along the bumper in a manner assisting a snug fit of the tent-like enclosure to the back area of the van. Otherwise than allowing the running of elastic rope along it, however, the van's rear bumper and use thereof is merely conventional.

Inherent to the nature of the Sylvesters' invention is that creation of the sheltered volume under their upswung door necessarily deprives the vacationers of ability to drive their self-propelled vehicle (the van). Vacation trailer users, as distinct from van camper users, do not sacrifice being able to drive their self-propelled vehicle during times when their unhitched overnight accomodation is set up, together with any extensions associatedly mounted thereto.

A disadvantage of the Sylvesters' mode of supporting their tent-like enclosure is that natural light from above is impeded from coming through any window in the van's rear door.

The tent's top piece is double-layered to be pulled onto the door “like a sock”, and this of course adds bulk to the quantity of material which must be carried within the van during travel, taking up more space than desirable within the same volume in which the vacationers are themselves conveyed. In contradistinction thereto, vacation trailer users do not travel in the trailer and thus would be less inconvenienced personally by carrying a tent therein—until, that is, the time for parking and setting up for their accomodations arrives. Then, absent specific provisions for otherwise, it would be necessary to unload the tent from among a crowd of items usually carried inside the trailer during travel, such as lawn furniture, portable barbecues, bicycles, wheelchairs, etc., with which the interior volume of a vacation trailer may typically be virtually packed full, since the vacationers themselves ride in the towing vehicle.

Such items of cargo often crowded into a trailer as just mentioned above shall be hereinafter called “outdoor portables”, and attention is here drawn to urgent need for efficient provisions and means for unloading outdoor portables from a vacation trailer, in a manner that ideally is helpfully cooperative with the further task of erecting a shelter immediately behind the trailer.

Insofar as the present inventor is aware, nobody of skill in the art of vacation trailer manufacture has previously suggested that the four categories of special technical elements itemized above, viz., (A) trailer-kneeling means, (B) removable outdoor portables carrier, (C) upswinging rear closure, and (D) detachable bumper, should not only be included, but should inter-functionally cooperate in the manner to be described.

### BRIEF SUMMARY OF THE INVENTION

The present contribution to advancement of the art of vacation trailer manufacture specifies a novel non-selfpropelled vacation trailer that embodies a unique combination of some conventional and some special vacation trailer elements, featuring among the latter the following four elements: (A) trailer-kneeling means integral to wheels-to-chassis suspension means and actuated preferably using controlled deflation of an expandible air receptacle associated with a suitable compressed air system; (B) a specially designed casters-wheeled carrier in which outdoor portables rest during periods of towing the trailer with the carrier fitted thereinto to function as a large removable drawer, and which facilitates unloading the outdoor portables after parking the trailer; (C) an upswinging rear door hinged at the level of the top of a trailer body of the otherwise conventional rounded-edges, rounded-cornered type, so that the door, held fully open, roofs over a sheltered area behind the parked trailer; and, (D) a bumper specially designed in two regards: it has a cavity for storage of screening or weather-proof fabric similar to awning or tent-making material; and, it detaches from the trailer chassis, preferably synchronously with a final step for outdoor portables carrier removal. Considered the most notable aspect of this invention is how effectively the foregoing special elements mutually cooperate with one another to efficiently attain the two major objects of the invention, which are: 1. efficient unloading of outdoor portables en passe from a parked trailer, without needing to individually handle each item; and 2. efficient erection of a sheltered area immediately behind the trailer.

Further specific objects of the invention include: to improve utility of a vacation trailer with respect to an individual who uses a wheelchair; to optimize use of available compressed air for a variety of technical purposes, including the leveling of a supporting surface on which a wheelchair may rest adjacent a dinner table temporarily placed just inside the rear portion of the trailer body; and, to procure all the benefits and advantages which would normally be expected to be procured by establishing an auxilliary sheltered area behind a parked trailer. Some of the benefits are, for example: more standing-room private area in which to change into or out of bathing suits; increased space for setting up cots, chairs, and/or a card table under shelter behind the trailer; and provision of an easily ventilated area where, if desired, smokers among guests to whom hospitality is shown may be accomodated.

In all particulars of its detailed description and operation, the invention will be best understood by recourse to the several figures of drawing next briefly identified.

### BRIEF DESCRIPTION OF THE DRAWING FIGURES

FIG. 1 is a partly cutaway side view of the trailer shown unkneeling.

FIG. 2 is a similar view as FIG. 1, but the trailer kneels, its rear door is open, and its outdoor portables carrier is shown in partial emergence.

FIG. 3 is a similar view as FIG. 2, but shows the outdoor portables carrier fully removed from the trailer body, although remaining in contact with the bumper.

FIG. 4 is a similar view as FIG. 3, but shows the bumper detached.

FIG. 5 is a similar view as FIG. 4, but shows the carrier and bumper separated.

FIG. 6 illustrates fabric in partial emergence from a cavity in the bumper.

FIG. 7 illustrates fabric in attachment to the upraised rear door, and is the preferred view for frontpage publication.

FIG. 8 illustrates use of the outdoor portables carrier as a wheelchair ramp.

FIG. 9 illustrates use of the outdoor portables carrier as a wheelchair platform.

FIG. 10 is a perspective view looking rearwardly within the trailer.

FIG. 11 is a similar view as FIG. 10, but after the set-up shown in FIG. 8.

FIG. 12 is a cross-sectional view of the door-roofed sheltered area, taken on the vertical plane bisecting the trailer.

FIG. 13 is a PRIOR ART figure.

### DETAILED DESCRIPTION OF THE INVENTION

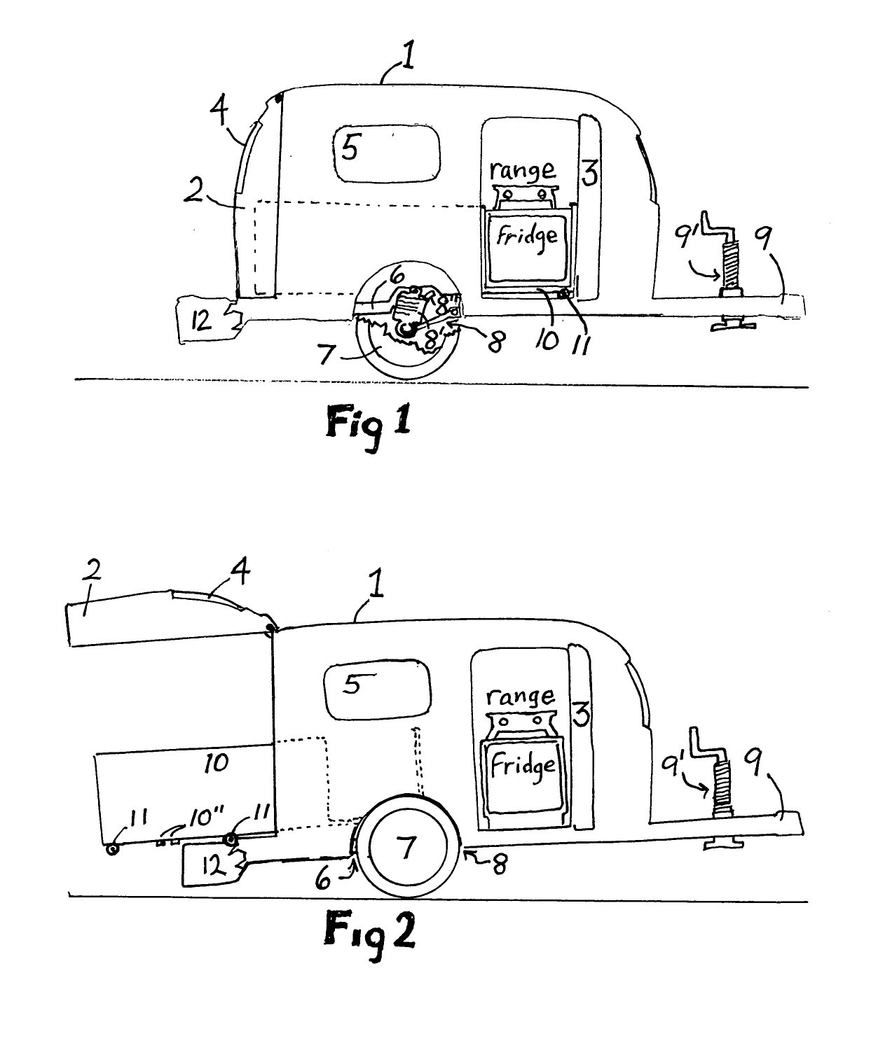

FIGS. 1-12 of the drawing illustrate a basic preferred version of the invention, and an elaborated version with certain refinements not shown in these figures will be mentioned much further below. The version illustrated is preferred because of its easier manufacturability, not because of any inferior aspect of performance of the more elaborated version contemplated. With reference to FIG. 1 illustrating a momentarily unkneeling vacation trailer having its rear door 2 closed and side door 3 open, it would be recognizable, to those acquainted with the molded fiberglass-bodied trailers formerly made in Winnipeg by Boler Manufacturing Limited, and with successor models of similar shape and layout although made by other enterprises, that a trailer embodying the present invention also exhibits a similar overall shape-resemblance and layout, especially with regard to the following external features: height-to-width-to-length general proportions; a rounded-edges/rounded-cornered body structure 1; a side door 3 near the front end; and the siting of rear and side windows, respectively enumerated 4 and 5. Other features shown include: a chassis 6, forward extension of which terminates in towing hitch 9, having a lowerable hitch support 9′ for use when the trailer is unhitched from a towing vehicle; bumper 12; roadable wheel 7, which of course has an opposed matching wheel as its counterpart on the opposite side of the trailer (unshown); and suspension means 8. The partially cut-away section of FIG. 1 is meant to disclose that suspension means 8 for connecting wheels 7 to chassis 6 includes an expandible compressed air receptacle 8′ and valve-controlled air line connectors 8″, further to be discussed below in association with how enactment of a trailer-kneeling action mutually cooperates with means for unloading outdoor portables, further in association with contemplating other useful functions that can be served owing to requisite inclusion of a suitably efficient compressed air provision system (unshown).

As soon as a trailer embodying the present invention kneels and has its upswinging rear door 2 held open as shown in FIG. 2, it becomes apparent that shape resemblances to trailers of the prior art—such as those formerly made by Boler Manufacturing Limited and some still made today by others in remarkably similar overall configuration—are only superficial. An immensely important functional difference is evident, because there was only its side door for access to enclosed volume within a Boler trailer, in consequence of which the unloading of any transported portable goods therefrom necessarily involved their removal through a Boler trailer's side door. That former limitation of having a single door only, at one side and near the front, also created another problem, besides impeding simultaneous entry of persons and exit of goods through the one door.

Outbound flow of portables through the side door also unavoidably caused crowding of workspace immediately adjacent a kitchenette facility normally installed with a cooking range atop a short refrigerator directly opposite the side door. Kitchenette area crowding due to flow of portables during unloading would be temporary, yet highly undesirable because of delaying opportunity to use the kitchenette immediately to start dinner, and this real practical problem is completely resolved by inclusion of rear door 2 in trailer body structure 1 of the present invention. A pair of vacationing partners can enter the new trailer's side door 3 in single-file and the first can instantly commence moving portables toward the rear and out the back of the trailer, while the second member of the pair, remaining in the front portion, can immediately commence preparation of a meal even before all the portables intended to be removed are entirely out of the trailer.

Also visible in the views presented by both FIGS. 1 and 3 is d side opening 10′ in the forward extending portion of an outdoor portables carrier 10, which is a very significant essential technical feature of the present invention, because it provides improved occasional brief access to the front portion of the trailer via the side door, eg., to easily reach across to the short refrigerator of the kitchenette area. Also seen through the opening associated with side door 3 (in FIG. 1) is the nearest of a pair of casters 11 suitably attached at the bottom of carrier 10 toward its rightmost end. Casters 11 are shown resting on bumper 12 in FIG. 3.

With reference now to FIG. 2, outdoor portables carrier 10 is shown (cantilevered) in partial emergence from the opened-up rear of trailer structure 1. Carrier 10 has been designed to function as a long open-topped drawer fitted to the interior of body structure 1 in such a way as to maximize ease of unloading a considerable quantity and weight of outdoor portables without necessity to handle them individually while still in the trailer. The portables with which such a “drawer” (so to speak of carrier 10) would contemplatedly be laden could include items like folding chairs, a card table, portable barbecue, tool box, bicycles, a wheelchair, and, at the end nearest rear door 2, a spare tire, none of which are specifically shown in the figures for reason of not wanting to clutter the drawing or tell vacationers what to take along in their travels. Generally, the portables contemplated would be relatively durable rather than fragile items, able to withstand a moderate extent of jouncing shock at times when one end or the other of carrier 10 drops a short distance.

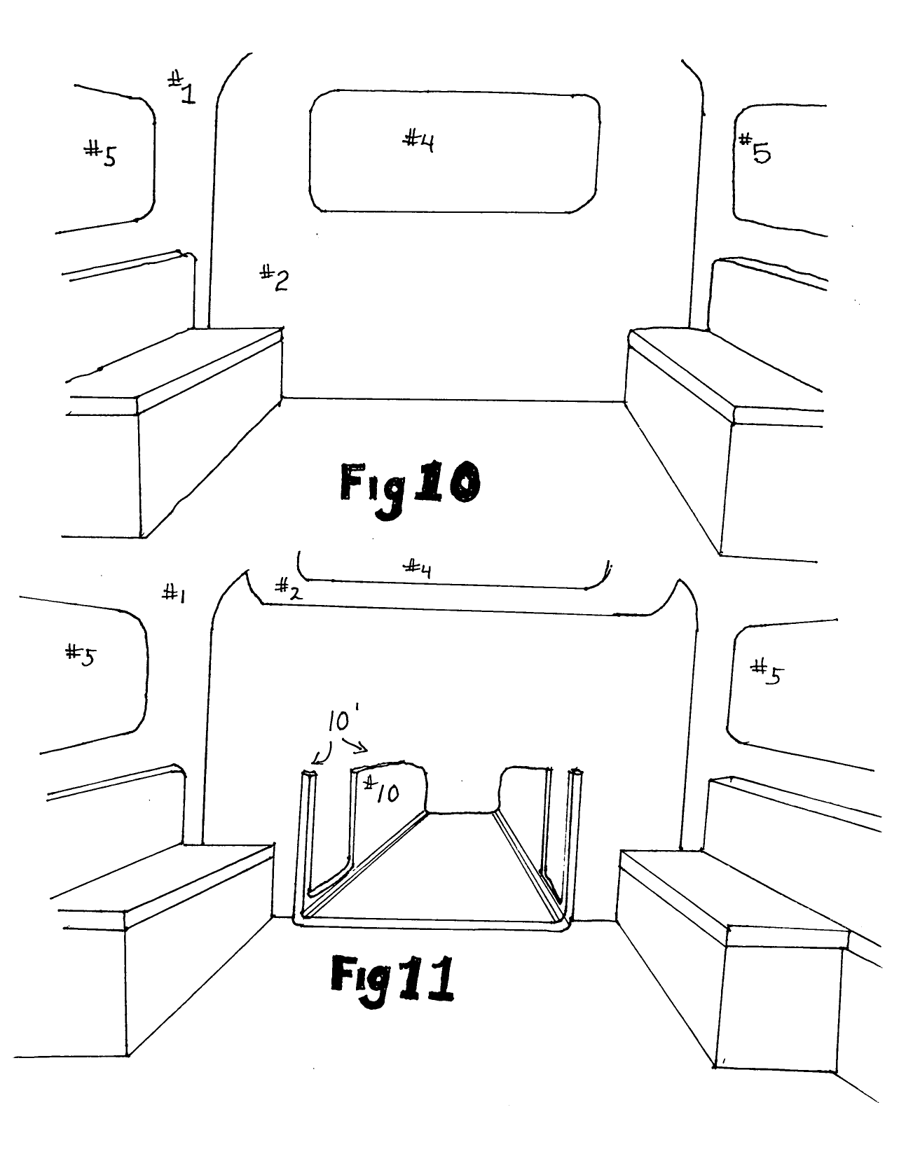

Brief inspection of FIGS. 10 and 11 will further persuade potential users how useful for clearing the trailer interior of portables the carrier 10 is. Reverting to FIG. 2, details of carrier 10 showing at its emerging portion include suitably attached rolling casters 11 and cleatlike clips 10′ adapted for receiving (on appropriate occasions) compressed-air actuated variable-height carrier supports 13 fitted thereto as shown in FIG. 9.

FIG. 3 shows the leftward end of carrier 10 having dropped to the ground with its leftward casters 11 now in contact therewith, while, at the same time, the rightward-mounted casters 11 have alighted atop bumper 12. A further pair of casters 11 on carrier 10 is also evident, between the two end pairs at a suitably selected location making them useful for sustaining backward rolling of carrier 10 out of trailer body structure 1 until so much of the leftward portion of carrier 10 has emerged that counterclockwise tilting of the whole carrier 10 inevitably must occur, which action indeed can be inferred from what FIG. 3 shows, in contrast to the immediately preceding figure.

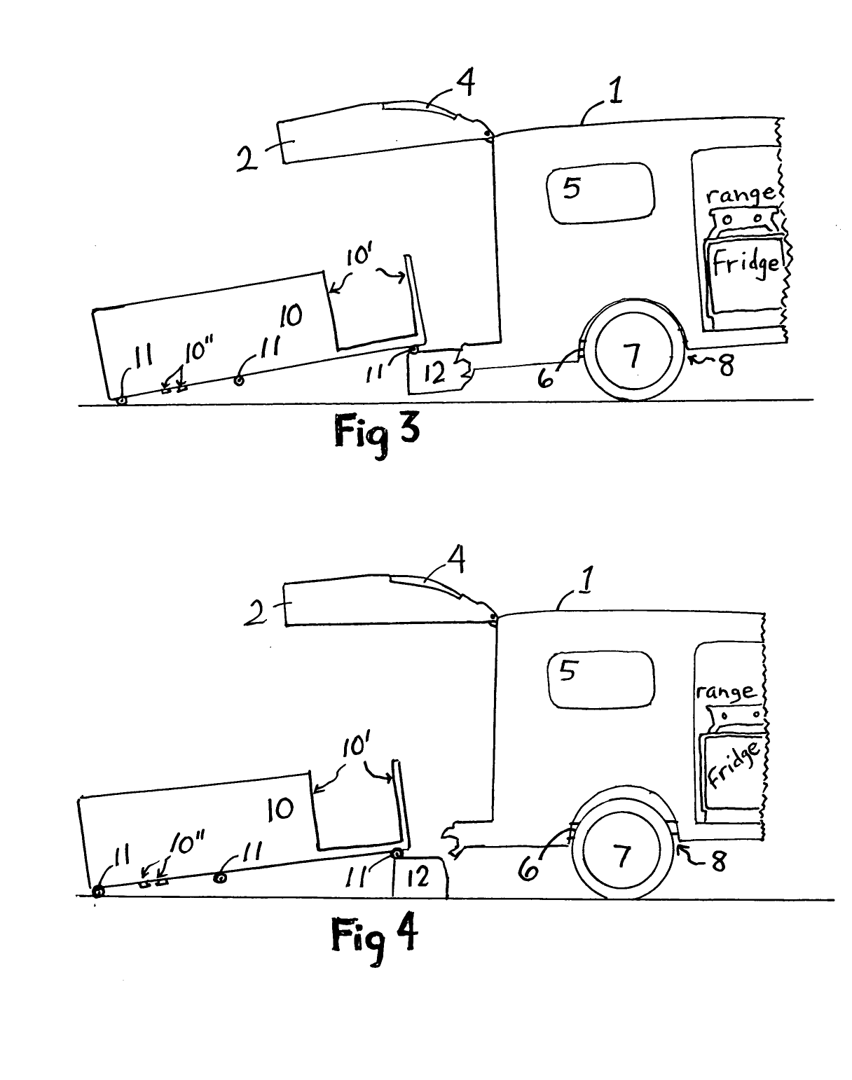

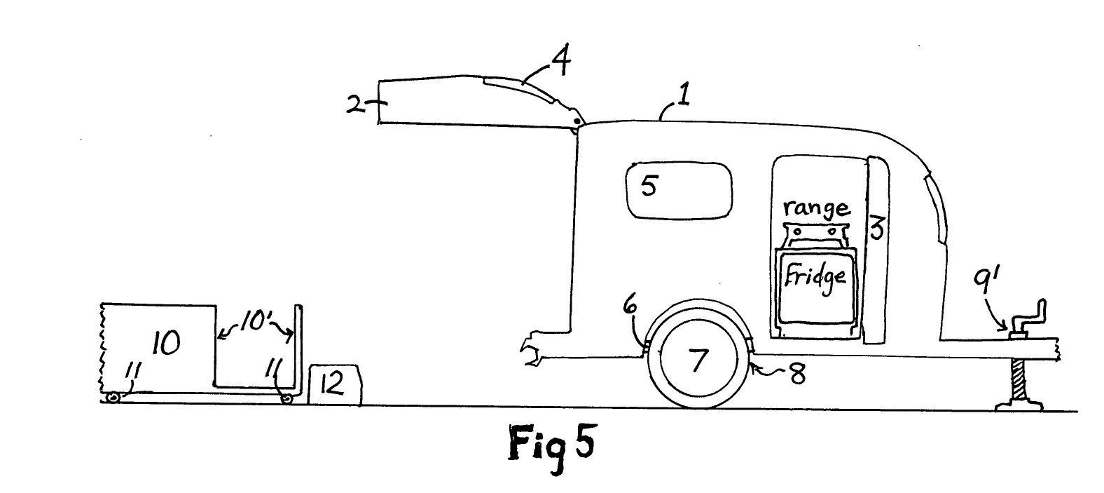

Next, showing of bumper 12 detached as in FIG. 4, now perused, associates with the special technical way with which screening and/or walling-in a sheltered area beneath upraised open rear door 2 is proposed to be accomplished. Before unfolding this aspect of the invention, however, warranting mention is the fact that today's technology of releasable connectors has reached a high state of development and affords a host of alternative devices ready to hand for the function of specially mounting bumper 12 to chassis 6 in such a way that the former may be readily detached from the latter when desired. After detaching bumper 12, the trailer should be pulled forward a sufficient distance to station the free leftmost end of upraised door 2 directly over bumper 12 lying on the ground, as shown in FIG. 5.

With reference to how FIG. 5 shows both bumper 12 on the ground and also outdoor portables carrier 10 on the ground too, it will be noted that in view of having pulled the trailer forward as mentioned, neither bumper 12 or carrier 10 will be within the area behind the trailer which is directly roofed-over by upraised door 2. This is important so as to leave that area clear initially, until such time as anything intended to be set up therewithin, eg., a card table and folding chairs, is set up. A cavity in bumper 12 opens to the right, facing the clear area.

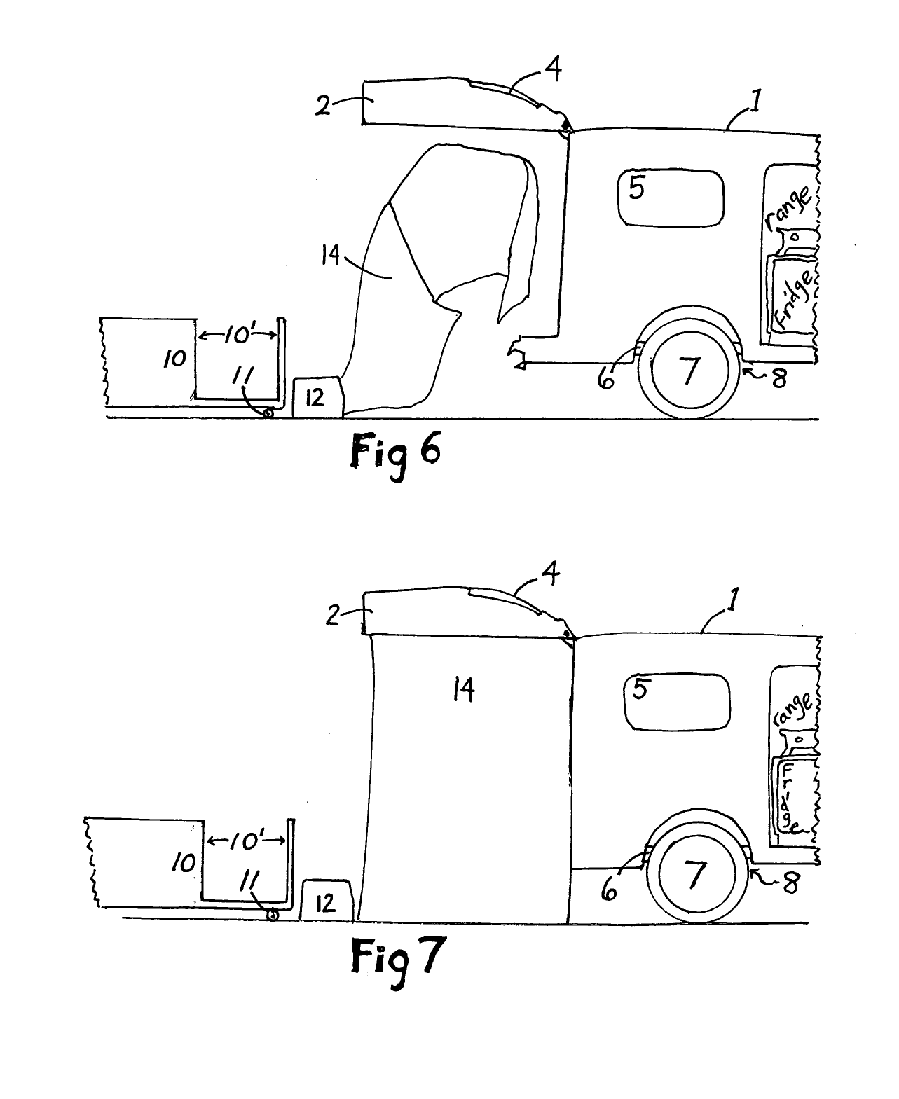

Having the area under door 2 initially clear is important from the aspect of a “set-up person”, typically the same who will have pushed loaded carrier 10 out from trailer body 1 while the partner commences cooking. The set-up person obtains shelter from rain and freedom to move around in underlying proximity to edges of upraised door 2, in order to affix thereto, using any suitable means (eg., snaps), corresponding edges of a piece or pieces of unrolled screening material or fabric 14, in order to wall-in the door-overhung area somewhat like the Sylvester's do in association with their “Camper van” invention, although in the present instance with major divergences from their exact plan. FIG. 6 illustrates from where walling-in material 14 is drawn in accordance with the present invention, viz., from a long cavity built into bumper 12 thereby serving as a storage receptacle for folded or rolled screening or fabric.

The material 14 is shown in partial emergence from cavitous bumper 12 by FIG. 6, but moving on to FIG. 7 makes it evident that all of material 14 is intended to be withdrawn for hanging up by suitable means from edges of upraised door 2.

Here is an opportune moment to reflect on how, as thus far taught explicitly (and to some extent implicitly as well), upraised door 2, outdoor portables carrier 10, and detachable cavitous bumper 12, considered together, clearly do not constitute a mere aggregation of normal vacation trailer features. As elements of a new and true combination, they mutually cooperate in a previously unsuggested process, enactment of which efficiently serves the objects of both facilitating unloading of removable portables from trailer body structure 1, and facilitating erection of a sheltered area behind the parked vacation trailer embodying the present invention. The substantial length of carrier 10 is such that it would not be feasible to use it to unload trailer-transported portables through the side door of a trailer like that formerly made by Boler Manufacturing Limited, nor could it swing 900 to exit through side door 3 in the present trailer. Being longer than the trailer is wide sheds light on removable carrier 10's need for cooperation of rear door 2 in the matter of unloading.

Moreover, the kneeling suspension means 8 plays a vitally cooperative role both in rolling carrier 10 out through the rear of vacation trailer, because the rear is lowered in relation to the point of hitch 9, assuming the latter to remain connected to the towing vehicle for the unloading operation. A variety of technical means are well known, whereby kneeling of a vehicle may be achieved, and what the cut-away section of FIG. 1 shows is merely suggestive. Kneeling systems used on public transit buses could readily be adapted to the purpose here.

After having been pulled forward as mentioned above, unhitching can be done and the trailer can be leveled owing to mutual cooperation between adjustable suspension means 8 and lowerable hitch support 9′ operable in the usual manner.

It now may be stated without technical inaccuracy that the kneeling/de-kneeling capability of suspension means 8 of the present invention provides cooperation with the other essential combination elements, in the service (as always) of the dual express major objects of the present vacation trailer invention: unloading of trailer transported portables; and shelter erection behind the parked vacation trailer. De-kneeling is readily understood to be effected by use in an expected manner of valve-controlled air line connectors 8″. If they are manipulated to send compressed air into expandible receptacle 8′, suspension means 8 will lift chassis 6 a few inches, whereas if they are manipulated to release air from receptacle 8′, then the kneeling action occurs. This matter is predicated, of course, on an assumption of including a suitable compressed air provision system (not shown).

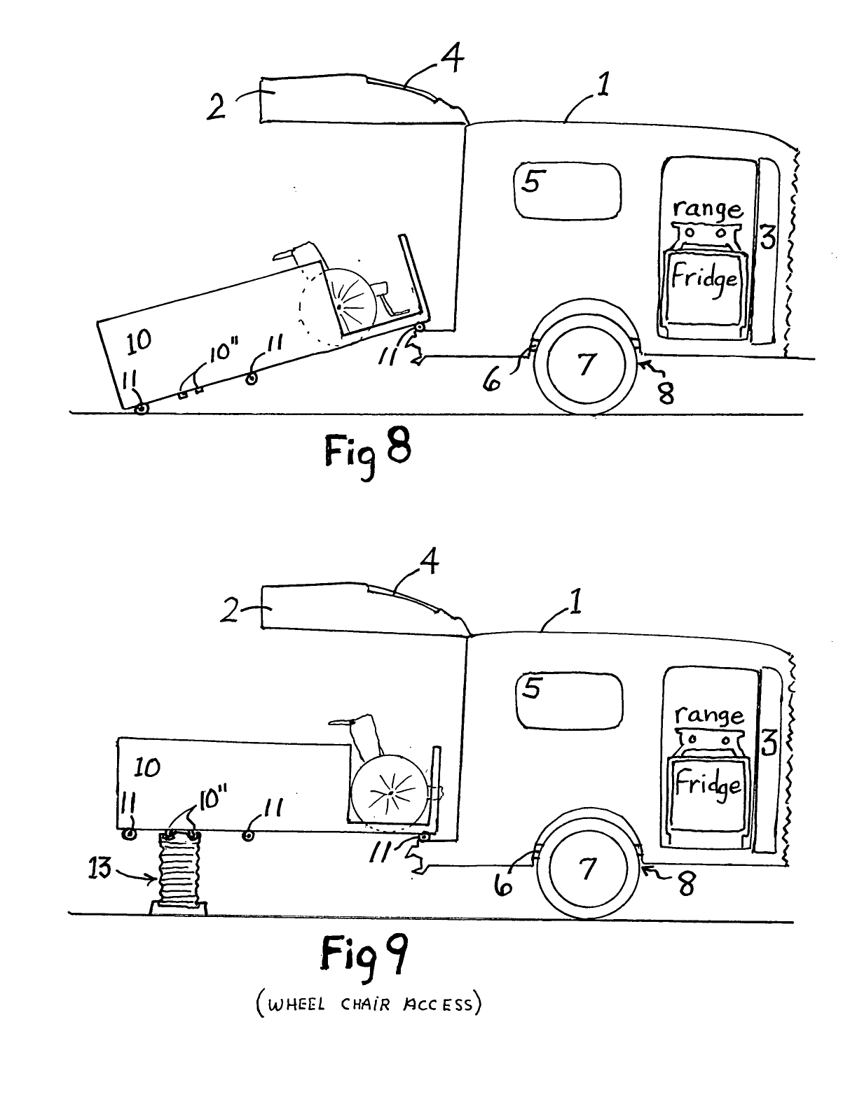

The same compressed air provision system can also be applied to using carrier 10 as a pneumatically leveled wheelchair platform as shown in FIG. 9. When it is desired to do this, compressed air actuated variable-height supports 13, in a deflated state initially, can be fitted to cleatlike clips 10″ on the underside of carrier 10, which, prior to what is shown in FIG. 9, would (as shown in FIG. 8) be supported at its rightward end on the back edge of the floor of trailer body 1 (assuming bumper 12 were previously detached). Open at its leftward end, carrier 10 furnishes a ramp for a person in a wheelchair as in FIG. 8. Inflation of supports 13 can be enacted so as to produce the leveled platform FIG. 9 shows. A wheelchair occupant could eat a meal at a temporary table set up in the rear of the trailer. Afterwards, reversing the carrier leveling actions would allow descent of the wheelchair.

Since a compressed air provision system is contemplated, additional pneumatic actions of utility are easily envisioned. Copies of cleatlike clips 10″ could be used on bumper 12 to facilitate raising it from the ground for reattachment to chassis 6 when breaking camp. A more elaborate version of the invention briefly considered can also use the compressed air provision system, as follows. Instead of having upswinging rear door 2 hinged directly to the topside of trailer body 1, it could hinge from a pair of rearwardly telescoping booms that are pneumatic in operation and run parallel with the trailer roof.

In such a case where an upswinging door need not first be upswung to open away from the enclosed volume, since it could slide backward away from the rear of the trailer while still in an upright state (the door), it may further be very useful to arrange suitable catch features on the lower portion of door 2, which could engage matching features on both carrier 10 and on detachable bumper 12, thereby to pull on them and carry them backwards. In other words, given suitable use of pneumatic power actuation techniques and long enough booms, these could easily be resorted to for pulling the carrier 10 out into a position similar to that shown in FIG. 9 except separated a distance from the back of the trailer, equal to the distance the trailer would be pulled forward from a detached bumper 12 when using the preferred simpler version. Supports like supports 13 except wheeled at the bottoms could be emplaced in clips 10″ to rollably support the bumper, which would be de-catched and moved by door 2 together with the carrier 10.

Moreover, after having used backward extension of pneumatically actuated booms atop the trailer to pull carrier 10 from trailer body 1 by means of a backward-moved upright door 2 catch-locked to carrier 10 (and also bumper 12), then, after emplacing and using more supports at the end of the carrier not resting on the bumper, the door could be detached from the pulled out carrier and bumper, followed by retracting the envisioned booms so as to return the door 2 forward to where it could finally be swung upward in the normal way to provide roofing over a clear area immediately behind the trailer. In this case, obviation of having to pull the trailer forward a short distance in the manner previously described would be achieved, since telescoping booms would take over the function of procuring the desired distancing/placement. Additionally, the cavity in the bumper would be positioned at a convenient height for walling material to be withdrawn without necessity of stooping.

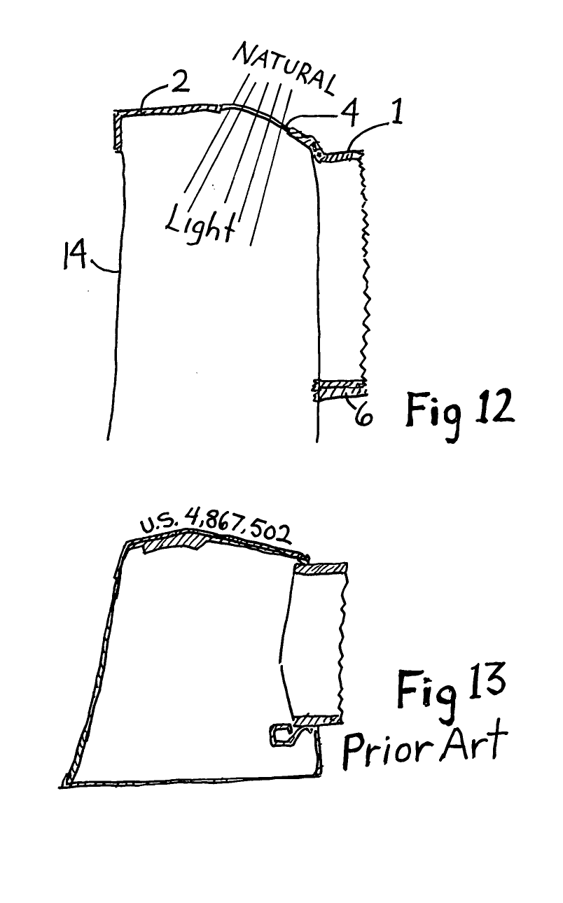

Returning to what has been illustrated in the figures, a comparison between the respective cross-sectiohal views of FIGS. 12 and 13 discloses that natural light from above is free to shine through window 4 into the sheltered area below upraised door 2, for the case of the present invention; whereas, for the PRIOR ART figure (FIG. 13) this is not inherently achieved. Although possible, this would be difficult to achieve because of the “sock-like” fitting of tenting material over the van door. Of course, if there were a window in the door, and if the pieces of material encasing the upraised door had vinyl panels as windows in them too, then light could shine through, although considerably more impeded than by a pane of clear glass alone.

It is thought that a large number of generally expectable modifications directed to a wide variety of useful functions and manners of use would come to the minds of workers skilled in the art to which the present invention pertains, once they grasp the key point of above teachings respecting desirability and practicability of establishing mutual cooperation among an upswinging rear door, removable portable goods carrier, detachable bumper, and pneumatically actuated trailer-kneeling suspension means. There is nothing new necessary to suggest or describe in detail concerning routine manufacturing in the sense of fabrication and assembly knowhow, because no special difficulties are raised which would tax the existing level of skill and knowledge of in the field.

Body parts molded of fiberglass or plastics, metal chassis elements, suitable wheels, towing hitches, suspension systems, and compressed air provision systems are all familiar items to the relevant artisans that has heretofore apparently been unknown amongst them is the here presented suggestion itself to make the new combination, which shall be legally defined only by the terms of claims following hereinafter.

1. For combination with conventional vacation trailer structural features comprising a chassis terminating at one end in a towing hitch attachable to a towing vehicle, a set of roadable wheels, suspension means connecting said wheels to said chassis, a trailer body mounted on said chassis, movable closure means for access to usable volume within said trailer body, and a bumper attached at the end of said chassis opposite said towing hitch,
the novel combination of four particularly adapted and constructed combinatory elements designated “(A)”, “(B)”, “(C)”, and “(D)”, which are effective for utilization in a mutually cooperative manner both amongst themselves and together with said conventional vacation trailer structural features, where said four particularly adapted and constructed combinatory elements are:
(A) means for causing said vacation trailer to kneel in a manner causing said bumper-bearing end of said chassis opposite said towing hitch to be lowered relative to a horizontal plane in which said hitch lies when said hitch remains in attachment to a towing vehicle;
(B) means for unloading a multiplicity of portable items from said vacation trailer without necessity of individually handling each item;
(C) means for roofing-over a sheltered area of predetermined dimensions behind said vacation trailer when parked, without positioning fabric atop a solid upward-opening rear door; and,
(D) a detachable bumper containing a cavity for storage of folded or rolled fabric and/or screening material usable to wall-in said sheltered area;
whereby incorporating said elements (A), (B), (C), and (D) in an otherwise conventional vacation trailer procures improved convenience when unloading portable items transported in the vacation trailer, and improved convenience when setting up a sheltered area behind the vacation trailer.

2. A vacation trailer comprising the combination defined in claim 1, wherein element (A), viz., said means for causing said vacation trailer to kneel, is actuated using compressed air.

3. A vacation trailer comprising the combination defined in claim 1, wherein element (B), viz., said means for unloading a multiplicity of portable items from said vacation trailer without necessity of individually handling each item, is a carrier that removably fits into the interior of said vacation trailer in a drawer-like manner, that is longer from one end to the other than said vacation trailer is wide, that is open-topped, open at least at the end nearest the rear of said trailer when said carrier is fitted thereinto, and has leftside and rightside openings near the end nearest the front of said trailer; and, that has a multiplicity of casters so mounted that said carrier tends to roll in the direction away from the towing hitch end of said trailer when said element (A) is operated to cause kneeling of said trailer before said towing hitch is detached from said towing vehicle.

4. A vacation trailer comprising the combination defined in claim 1, wherein element (C), viz., said detachable bumper, is particularly adapted and constructed to detach from said chassis in accordance with a procedure dropping said bumper to the ground with one end of element (B), viz., said drawer-like carrier, temporarily resting on said bumper.

5. A vacation trailer comprising the combination defined in claim 1, wherein element (D), viz., said means for roofing-over said sheltered area behind said vacation trailer without necessity of positioning fabric atop a solid upward-opening rear door, is an upward-opening rear door having a window therein which provides a skylight letting natural light into said sheltered area from above.
